(19) United States
(12) Patent Application Publication
(10) Pub. No.: US 2025/0191039 A1
(43) Pub. Date: Jun. 12, 2025

(54) SERVER, CONTROL METHOD THEREOF, STORAGE MEDIUM, AND SYSTEM

(71) Applicant: CANON KABUSHIKI KAISHA, Tokyo (JP)

(72) Inventor: MANAMI HATANO, Kanagawa (JP)

(21) Appl. No.: 18/974,463

(22) Filed: Dec. 9, 2024

(30) Foreign Application Priority Data
Dec. 12, 2023 (JP) 2023-209108

(51) Int. Cl. G06Q 30/04; G06F 3/12

(52) U.S. Cl. CPC G06Q 30/04; G06F 3/1203; G06F 3/1272

(57) ABSTRACT

A server causes a display unit of a second information processing device to display a screen displaying a list of print jobs that are not based on a contract and are for use other than business use and print jobs that are not confirmed as print jobs for use other than business use in stored print job information, receives selection of a print job not based on a contract and for use other than business use as a settlement target job by a user from a list of the print jobs, and causes the display unit to display a settlement screen for presenting billing information and a settlement method based on a second rule for the selected print job and executing settlement processing based on an operation performed by the user.

### BACKGROUND

### Field

The present disclosure relates to a server for performing billing processing on print jobs for an image forming apparatus, a control method of the server, a storage medium, and a system.

### Description of the Related Art

In recent years, a contract of a form as described below has been spreading as a technique to manage operational costs of an image forming apparatus. That is, a provider that provides services using the image forming apparatus and a user that uses the services set an upper limit of the number of pages to be printed within a predetermined period, and the user pays a predetermined amount of money for the set upper limit.

As various working styles, such as teleworking and working at a satellite office, have been adopted, more users involved in business using services for an image forming apparatus for which the services defined in the contract as described above are provided install the image forming apparatus in a user's place. In this case, some of the users may wish to use the image forming apparatus for any use other than business use out of office hours. However, in general, print jobs for any use other than business use are not covered in the contract, and an extra charge is incurred.

Heretofore, various techniques for appropriately performing billing processing on each print job in a case where print jobs to be executed by an image forming apparatus include a plurality of billing forms and billing targets have been discussed. Examples of such techniques include a technique for assigning a department code to each department and designating the department code when the image forming apparatus is operated in the department, and a technique for determining an owner of each print job based on user information held in an operation system on which an application for printing runs. Other examples of such techniques include a billing code used to identify a billing destination for each document based on a case to which the document belongs. Japanese Patent Application Laid-Open No. 2016-5227 discusses a technique for calculating a billing amount by obtaining and using setting information about each user when the user performs an operation for printing.

However, it has not been considered to receive a selection from the user of the image forming apparatus and to determine a billing method for each print job based on the selection.

### SUMMARY

The present disclosure is directed to providing a billing system in which a user of an image forming apparatus can arbitrarily use the image forming apparatus regardless of the intended use and settlement processing for any use other than business use can be selectively performed.

According to an aspect of the present disclosure, a server communicably connected to an information processing device and an image forming apparatus via a network includes at least one memory storing at least one program and at least one processor, the at least one processor configured to execute the at least one program to perform processing comprising storing information input from a first information processing device indicating a print job executed by the image forming apparatus, generating billing information based on a first rule for a print job based on a contract and a second rule for a print job not based on the contract and for use other than business use, causing a display unit of a second information processing device to display a screen displaying a list of print jobs not based on the contract and for use other than business use and print jobs not based on the contract and not confirmed as print jobs for use other than business use in the stored print job information, receiving a selection of a print job not based on the contract and for use other than business use as a settlement target job from the list of the print jobs by a user, causing the display unit to display a settlement screen for presenting billing information and a settlement method based on the second rule for the selected print job, and executing settlement processing based on an operation performed by the user.

Further features of the present disclosure will become apparent from the following description of exemplary embodiments with reference to the attached drawings.

### BRIEF DESCRIPTION OF THE DRAWINGS

FIG. 1 is an overall view of a system according to a first exemplary embodiment of the present disclosure.

FIGS. 2A to 2C are block diagrams each illustrating a software configuration of the server according to the first exemplary embodiment.

FIG. 3 is a block diagram illustrating a hardware configuration of an image forming apparatus according to the first exemplary embodiment.

FIG. 4 is a block diagram illustrating a hardware configuration of an information processing device according to the first exemplary embodiment.

FIG. 5 is a block diagram illustrating a hardware configuration of a mobile information terminal according to the first exemplary embodiment.

FIG. 6 illustrates a processing flow from input of a print job to completion of print processing according to the first exemplary embodiment.

FIG. 7A illustrates a flow of settlement processing on a print job for use other than business use according to the first exemplary embodiment.

FIG. 7B illustrates a flow of settlement processing on a print job for use other than business use according to the first exemplary embodiment.

FIG. 8 illustrates a job selection screen displayed on the mobile information terminal according to the first exemplary embodiment.

FIG. 9 illustrates a selected job details screen according to the first exemplary embodiment.

FIGS. 10A and 10B illustrate a flow of processing for determining whether an upper limit of a billing amount is approached according to a second exemplary embodiment of the present disclosure.

FIG. 11 illustrates a job selection screen displayed on the mobile information terminal according to another exemplary embodiment.

FIG. 12 illustrates a selected job details screen (thumbnail) according to the another exemplary embodiment.

FIG. 13 illustrates a setting screen for a word to be concealed according to still another exemplary embodiment.

### DESCRIPTION OF THE EMBODIMENTS

Exemplary embodiments of the present disclosure will be described below with reference to the attached drawings.

The following exemplary embodiments are not intended to limit the scope of the attached claims, and not all the combinations of features described in the exemplary embodiments are essential to solve the problems in the present disclosure.

### Overall Configuration of System

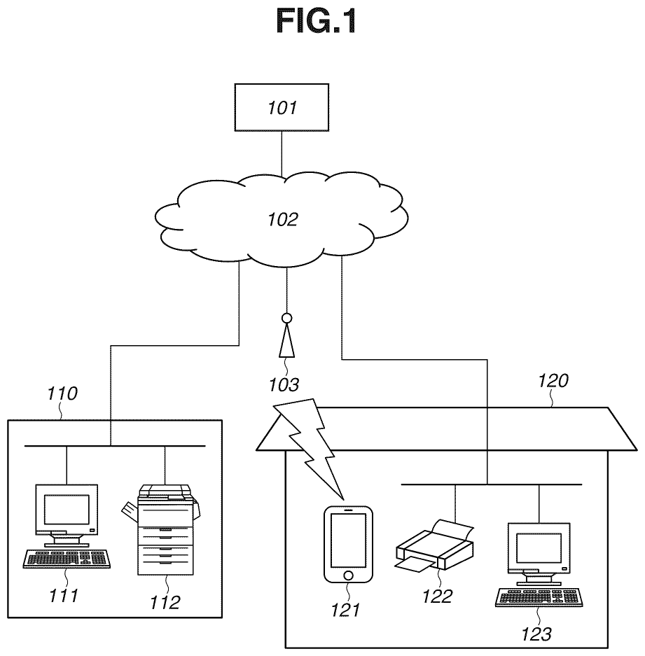

FIG. 1 schematically illustrates an overall configuration of a system according to a first exemplary embodiment of the present disclosure.

A server 101 provides a billing service in this system. While FIG. 1 illustrates the server 101 as a single device, the server 101 may be one of various services. Alternatively, the server 101 may have a service cluster configuration implemented across a plurality of server devices. More alternatively, the server 101 may be constructed on a virtual machine, instead of functioning as a physical computer.

Internet 102 is a network virtual layer and has no physical structure, and is represented by a cloud symbol.

An access point 103 is an access point of a wide area network (WAN). Examples of the access point 103 include a base station for mobile communication, and an access point of a wide area wireless network. Among these examples, an access point connected to the Internet 102 is expressed as an access point of the WAN.

An office 110 is held by a user that uses this service.

A first information processing device 111 is, for example, a personal computer (PC) placed in the office 110. The first information processing device 111 is not limited only to a physical computer, but instead may be a virtual machine placed in an intranet.

A first image forming apparatus 112 is an image forming apparatus placed in the office 110. While FIG. 1 illustrates an image forming apparatus for office use as the first image forming apparatus 112, an image forming apparatus for small or midsize business (hereinafter “SMB”) or an image forming apparatus for small office/home office (hereinafter “SOHO”) may also be used as the first image forming apparatus 112.

A remote working environment 120 is, for example, a user's place, a satellite office, and a shared office, which belong to a service user that uses the service.

A mobile information terminal 121 serving as an information processing device is, for example, a smartphone or a tablet computer, and is connected to a network. In this case, the mobile information terminal 121 is wirelessly connected to the WAN from the access point 103 and is further connected to the Internet 102. The mobile information terminal 121 is not limited only to the above-described examples. Any information processing device that is connectable to a network and is configured to perform information processing may be used.

A second image forming apparatus 122 is an image forming apparatus installed in the remote working environment 120. In this case, the second image forming apparatus 122 is an image forming apparatus for SOHO, but instead may be an image forming apparatus for SMB or for an office.

A second information processing device 123 is a PC installed in the remote working environment 120. However, the second information processing device 123 is not limited only to a PC.

### Software Configuration of Server

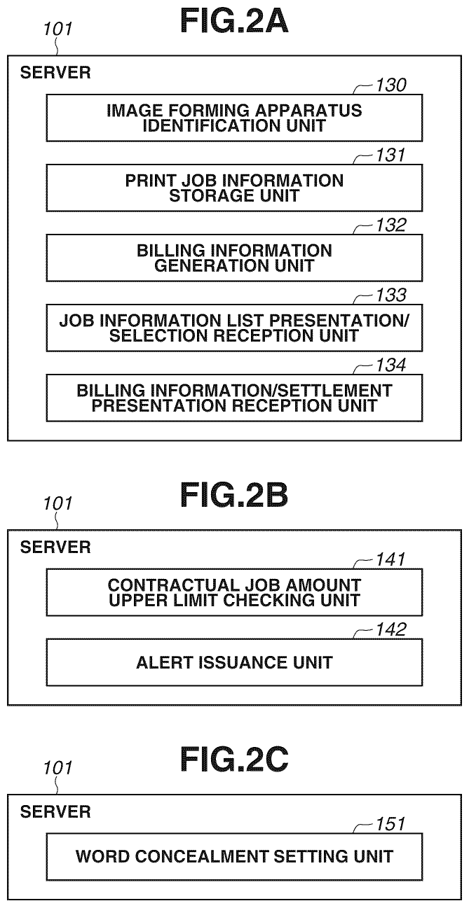

Next, a software configuration of the server 101 will be described with reference to a block diagram of FIG. 2A. Software to be described below is implemented such that a central processing unit (CPU) of the server 101 loads the software program into a random access memory (RAM) and executes the program.

An image forming apparatus identification unit 130 determines the image forming apparatus on which job selection and settlement processing are to be executed.

A print job information storage unit 131 stores information about print jobs that are input to the first and second image forming apparatuses 112 and 122 and are processed therein in the office 110 and the remote working environment 120, respectively.

A billing information generation unit 132 manages a first billing rule for determining a billing amount for a print job based on a contract, and a second billing rule for determining a billing amount for a print job that is not based on the contract and is for use other than business use, and calculates the billing amount based on actual job information.

A job information list presentation/selection reception unit 133 lists information about jobs processed by the first and second image forming apparatuses 112 and 122 identified by the image forming apparatus identification unit 130, presents the list, and receives a selection of print jobs that are for business use or not.

A billing information/settlement presentation reception unit 134 presents a billing content generated by the billing information generation unit 132 based on the selected content received by the job information list presentation/selection reception unit 133 and a settlement method, and receives settlement processing.

### Hardware Configuration of Image Forming Apparatuses

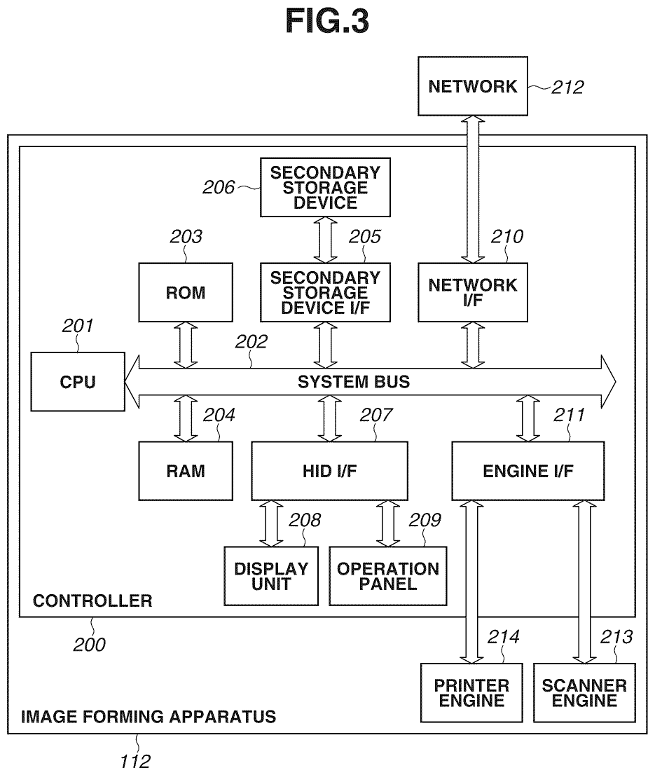

Next, a hardware configuration of each of the first and second image forming apparatuses 112 and 122 will be described with reference to FIG. 3. While FIG. 3 illustrates a basic structure of the first image forming apparatus 112 as a representative example, the basic structure of the second image forming apparatus 122 is identical to the basic structure of the first image forming apparatus 112.

A controller 200 controls the overall operation of the first image forming apparatus 112 in an integrated manner. The controller 200 includes functions for, for example, controlling the first image forming apparatus 112 to communicate with an external network, controlling a printer and a scanner to process print job data, and controlling an interface for a human to perform an operation.

A CPU 201 loads control programs stored in a read-only memory (ROM) 203 or a secondary storage device 206 into a RAM 204 and executes the control programs, thereby controlling various devices connected to a system bus 202 in an integrated manner via interfaces (I/Fs) of the devices.

The system bus 202 communicably connects the CPU 201, the ROM 203, the RAM 204, a secondary storage device I/F 205, a network I/F 210, a human interface device (HID) I/F 207, and an engine I/F 211 to each other.

The ROM 203 stores programs such as control programs and data.

The RAM 204 mainly functions as a main memory, a work area, or the like for the CPU 201.

The secondary storage device I/F 205 mediates communication between the secondary storage device 206 and the system bus 202.

The HID I/F 207 connects human interface devices, such as a display unit 208 and an operation panel 209, to the system bus 202.

The network I/F 210 connects the first and second image forming apparatuses 112 and 122 to an external network 212.

The engine I/F 211 includes a function for connecting the first and second image forming apparatuses 112 and 122 to a printer engine 214 and a scanner engine 213.

The printer engine 214 provides a printer function and the scanner engine 213 provides a scanner function.

### Hardware Configuration of Information Processing Devices

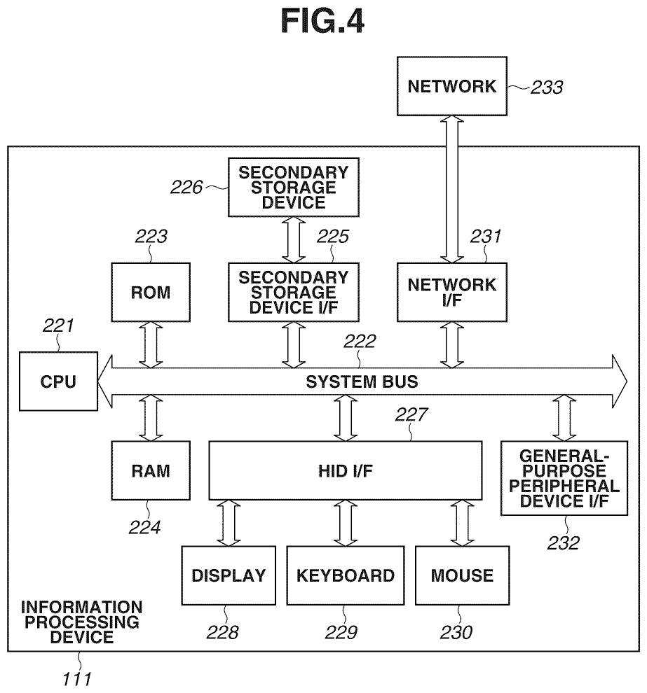

Next, a hardware configuration of each of the first and second information processing devices 111 and 123 will be described with reference to FIG. 4. While FIG. 4 illustrates a basic structure of the first information processing device 111 as a representative example, the basic structure of the second information processing device 123 is identical to the basic structure of the first information processing device 111.

A CPU 221 loads control programs stored in a ROM 223 or a secondary storage device 226 into a RAM 224 and executes the control programs, thereby controlling various devices connected to a system bus 222 in an integrated manner via I/Fs of the devices.

The system bus 222 communicably connects the CPU 221, the ROM 223, the RAM 224, a secondary storage device I/F 225, a network I/F 231, a HID I/F 227, and a general-purpose peripheral device I/F 232 to each other.

The ROM 223 stores programs such as control programs and data.

The RAM 224 mainly functions as a main memory, a work area, or the like for the CPU 221.

The secondary storage device I/F 225 mediates communication between the secondary storage device 226 and the system bus 222.

The HID I/F 227 connects human interface devices such as a display 228, a keyboard 229, and a mouse 230 to the system bus 222.

The network I/F 231 connects the first and second information processing devices 111 and 123 to an external network 233.

The general-purpose peripheral device I/F 232 connects other peripheral devices.

### Hardware Configuration of Mobile Information Terminal

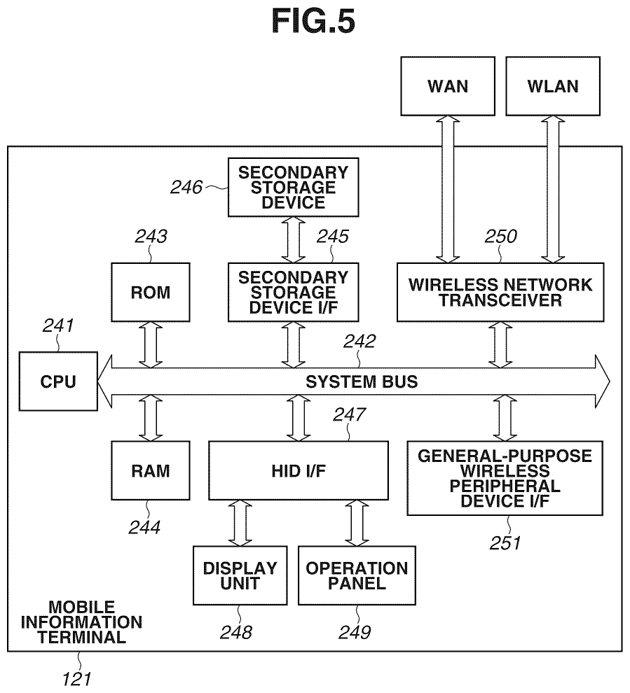

Next, a hardware configuration of the mobile information terminal 121 will be described with reference to FIG. 5.

A CPU 241 loads control programs stored in a ROM 243 or a secondary storage device 246 into a RAM 244 and executes the control programs, thereby controlling various devices connected to a system bus 242 in an integrated manner via I/Fs of the devices.

The system bus 242 communicably connects the CPU 241, the ROM 243, the RAM 244, a secondary storage device I/F 245, a wireless network transceiver 250, a HID I/F 247, and a general-purpose wireless peripheral device I/F 251.

The ROM 243 stores programs such as control programs and data.

The RAM 244 mainly functions as a main memory, a work area, or the like for the CPU 241.

The secondary storage device I/F 245 mediates communication between the secondary storage device 246 and the system bus 242.

The HID I/F 247 connects human interface devices such as a display unit 248 and an operation panel 249 to the system bus 242.

The wireless network transceiver 250 connects the mobile information terminal 121 to a WAN and a wireless local area network (WLAN) such as a local wireless network.

The general-purpose wireless peripheral device I/F 251 also wirelessly connects the mobile information terminal 121 to peripheral devices.

### Print Processing

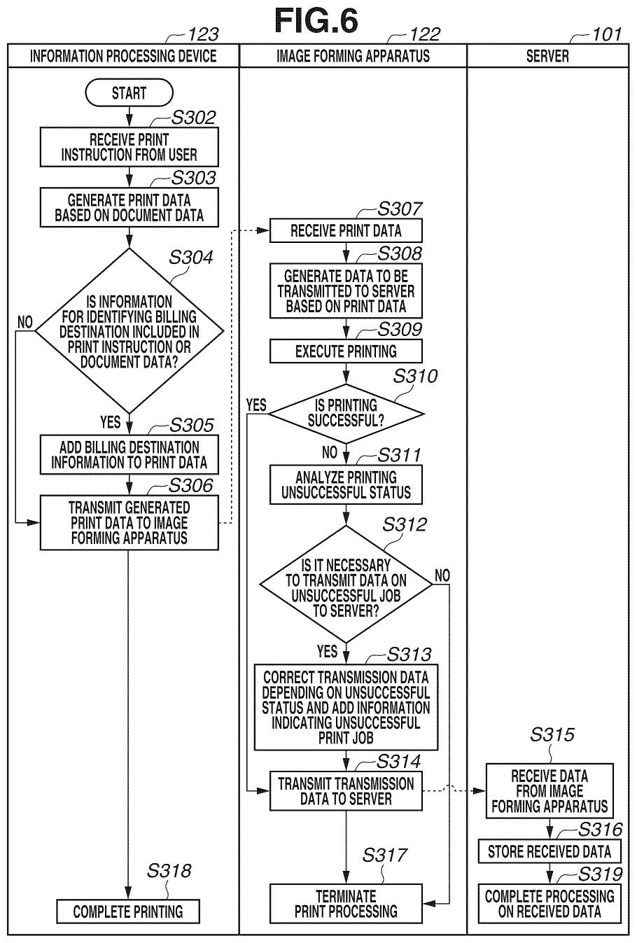

Next, a flow of print processing from input of a print job to completion of printing in the system according to the first exemplary embodiment of the present disclosure will be described with reference to a flowchart of FIG. 6. Processing in which the user performs printing using the second information processing device 123 in the remote working environment 120 will now be described. Each step to be described below is represented by “S”.

This processing is implemented such that the CPU 221 of the second information processing device 123, the CPU 201 of the second image forming apparatus 122, and the CPU of the server 101 execute programs for the processing. This processing is started in response to a user operation.

### <Second Information Processing Device 123>

In step S302, the second information processing device 123 receives a document printing operation from the user.

In step S303, the second information processing device 123 generates print data.

In step S304, the second information processing device 123 checks a print instruction and determines whether the print instruction or document data includes information for identifying a billing destination.

For example, a situation where the print instruction includes information for identifying a billing destination will now be described. An example of the situation is a case where the print instruction is issued in a state where the user has logged using an account that is clearly associated with business on the second information processing device 123. Another example of the situation is a case where a user interface for designating a billing destination when a print instruction is issued on an application used to issue a document print instruction is installed and the user interface is operated when the user issues the print instruction. Still another example of the situation where document data includes information for identifying a billing destination is a case where an attribute value of document data includes a code for identifying the billing destination and the code can be recognized by a program for printing.

If the CPU 221 of the second information processing device 123 determines that the information as described above is included (YES in step S304), the processing proceeds to step S305. If the CPU 221 determines that the information is not included (NO in step S304), the processing proceeds to step S306.

In step S305, since the information for identifying the billing destination is included in the print instruction or document data, information about the billing destination is further added to the print data generated in step S303. Then, the processing proceeds to step S306.

In step S306, the CPU 221 transmits the generated print data to the second image forming apparatus 122.

After completion of transmission by the CPU 221 of the second information processing device 123, the processing proceeds to step S318. In step S318, print processing on the second information processing device 123 is completed.

### <Second Image Forming Apparatus 122>

In step S307, the CPU 201 of the second image forming apparatus 122 receives the print data from the second information processing device 123.

Next, in step S308, the CPU 201 of the second image forming apparatus 122 extracts information from the print data and generates data to be transmitted to the server 101. In this case, the data to be transmitted to the server 101 includes, for example, information as illustrated in Table 1.

TABLE 1

| | Information Item | |
|---|---|---|
| No. | Name | Information Content |
| 1 | Image forming | A unique number assigned to identify an image forming |
| | apparatus | apparatus |
| | identification | |
| | number | |
| 2 | Print job | A print job identification number as a unique number |
| | identification | assigned to identify a print job |
| | number | |
| 3 | Print job document | A document name assigned to a print job so that a human |
| | name | can recognize the document name |
| 4 | Print job billing | A value set in step S305 identifies a billing destination to |
| | destination | which a print job belongs. For example, an identification |
| | identification | number for identifying a department, a user, a billing |
| | number | destination, or the like is set. If the billing destination is |
| | | uncertain, a value indicating an uncertain billing destination |
| | | is set. |
| 5 | Print job first-page | Image data on a first page of a printed document |
| | screen image | |
| 6 | Print job total page | Total number of printed pages |
| | number | |
| 7 | Number of colors | Settings such as full-color printing, monochrome printing, or |
| | in a print job | mono-color printing |
| 8 | Print job finishing | Information related to finishing processing such as |
| | information | imposition or one-sided or double-sided printing, or the |
| | | number of finally output sheets |

Next, in step S309, the CPU 201 of the second image forming apparatus 122 executes print processing.

In step S310, the CPU 201 of the second image forming apparatus 122 determines whether the print processing is successful. If the CPU 201 determines that the print processing is successful (YES in step S310), the processing proceeds to step S314. If the CPU 201 determines that the print processing is unsuccessful (NO in step S310), the processing proceeds to step S311. The case where the print processing is unsuccessful indicates a status where, for example, printing has not been executed, printing has been partially executed, or a sheet that is not printed is output.

In step S311, the CPU 201 of the second image forming apparatus 122 analyzes the status where printing is unsuccessful.

Next, in step S312, the CPU 201 of the second image forming apparatus 122 determines whether to transmit data to the server 101.

The case where data is to be transmitted to the server 101 indicates a state where some resource is consumed, for example, a state where a sheet on which printing is executed at least partially is output, or a state where printing is not executed and a blank sheet is output. If the CPU 201 of the second image forming apparatus 122 determines that data is to be transmitted (YES in step S312), the processing proceeds to step S313. If the CPU 201 determines that no data is to be transmitted (NO in step S312), that is, for example, in a case where printing is not executed at all and no sheet is output, the processing proceeds to step S317.

In step S313, the CPU 201 of the second image forming apparatus 122 adds the number of printed pages and the number of output sheets, as well as information indicating that the print job is unsuccessful, to the data to be transmitted. Specifically, in this case, the data to be transmitted includes not only the information illustrated in Table 1, but also information such as a print failure flag illustrated in Table 2.

TABLE 2

| No. | Information Item Name | Information Content |
|---|---|---|
| 9 | Print Failure Flag | Flag indicating an unsuccessful print job |

If this print failure flag is assigned to the data to be transmitted, the number of actually printed pages and the number of output sheets are written or set on the total number of pages in the print job and finishing information about the print job.

After completion of addition of information to the data to be transmitted, the processing proceeds to step S314.

In step S314 to be executed after printing is successful in step S310 and transmission data to which data on unsuccessful printing is added in step S313 is created, the CPU 201 of the second image forming apparatus 122 transmits the transmission data to the server 101. After the CPU 201 of the second image forming apparatus 122 has completed transmission of the transmission data, the processing proceeds to step S317.

In step S317, print processing on the second image forming apparatus 122 ends.

### <Server 101>

In step S315, the server 101 receives the data transmitted from the second image forming apparatus 122 in step S314.

In step S316, the server 101 causes the image forming apparatus identification unit 130 to identify the second image forming apparatus 122, and performs storing in the print job information storage unit 131.

In step S319, the server 101 completes processing on the received data and completes processing associated with a series of printing operations.

Steps S317, S318, and S319 are completed at different timings within the second image forming apparatus 122, the second information processing device 123, and the server 101, respectively, and the processes of steps S317, S318, and S319 need not necessarily be executed in synchronization.

Although the case where printing is executed in the remote working environment 120 is described above, the basic processing flow is also the same as that when printing is executed in the office 110.

### Settlement Processing

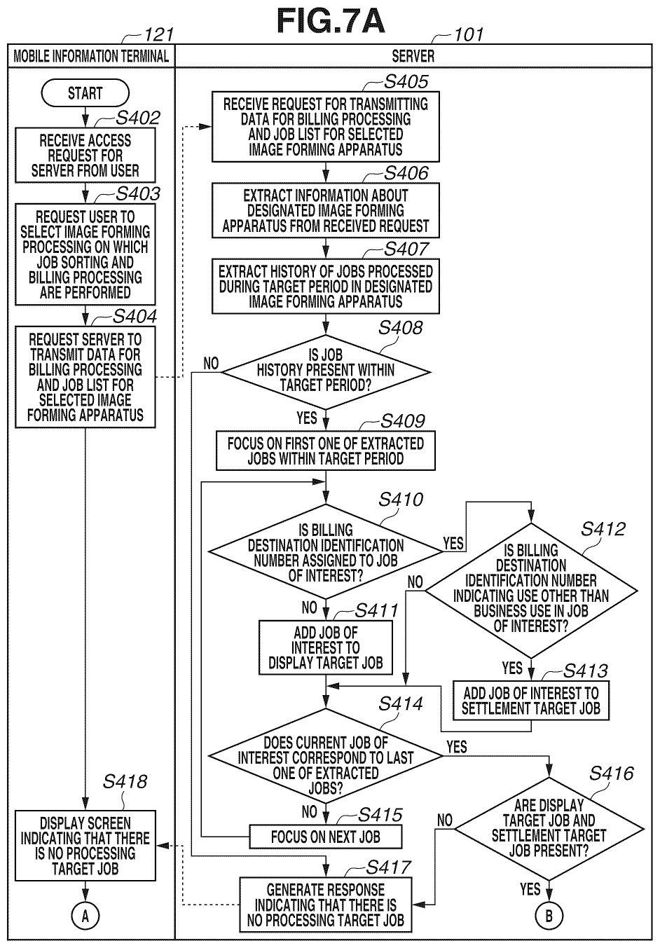

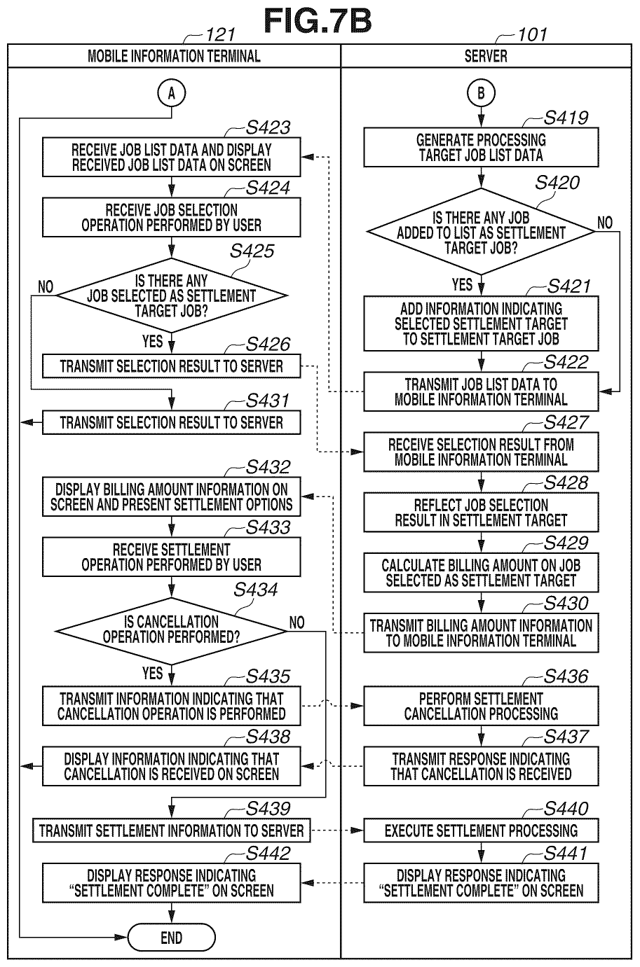

Next, a flow of processing from sorting of print jobs by the user to settlement of print jobs for use other than business use according to the first exemplary embodiment of the present disclosure will be described with reference to flowcharts of FIGS. 7A and 7B. Although an example where the user performs an operation using the mobile information terminal 121 as an information processing device is described below, the basic processing flow is also the same as that when the user performs an operation from the second information processing device 123 via a web browser or the like.

This processing is implemented such that the CPU 241 of the mobile information terminal 121 and the CPU of the server 101 execute programs for the processing. This processing is started when the user starts a program for settlement processing on the mobile information terminal 121.

### <Mobile Information Terminal 121>

First, in step S402, the CPU 241 of the mobile information terminal 121 receives an operation of accessing the server 101 to use the service by the user.

In step S403, the CPU 241 of the mobile information terminal 121 requests the user to select the image forming apparatus on which job sorting and billing processing are to be performed. If there is only one target image forming apparatus, this step may be omitted. In this step, the image forming apparatus may be implicitly designated, for example, for the reason that the same processing has been performed on the mobile information terminal 121 and a request for checking whether the designation is confirmed may be transmitted.

In step S404, the mobile information terminal 121 requests the server 101 to transmit a job list for the selected image forming apparatus and data for billing processing.

### <Server 101>

In step S405, the server 101 receives the request for the job list for the selected image forming apparatus and data for billing processing transmitted in step S404 from the mobile information terminal 121.

In step S406, the image forming apparatus identification unit 130 extracts information for identifying the image forming apparatus included in the content of the request.

In step S407, the server 101 extracts a history of jobs processed during a target period on the second image forming apparatus 122 from the print job information storage unit 131.

In step S408, the server 101 determines whether the job history is present within the target period. If the job history is present (YES in step S408), the processing proceeds to step S409. If the job history is not present (NO in step S408), the processing proceeds to step S417.

In step S409, the server 101 focuses on the first one of the extracted jobs within the target period.

In step S410, the server 101 determines whether the billing destination identification number (No. 4 in Table 1) is assigned to the job of interest. If the server 101 determines that the billing destination identification number is not assigned to the job of interest (NO in step S410), the processing proceeds to step S411. If the billing destination identification number is assigned to the job of interest and the billing destination is determined (YES in step S410), the processing proceeds to step S412.

In step S411, the server 101 adds the current job of interest as a display target job. After completion of addition, the processing proceeds to step S414.

On the other hand, in step S412, the server 101 determines whether the billing destination of the job of interest indicates a job for use other than business use. If the job of interest is not a job for use other than business use, or is a job for which the billing destination for business use is designated (NO in step S412), the processing proceeds to step S414. On the other hand, if the server 101 determines that the billing designation indicates a job for use other than business use (YES in step S412), the processing proceeds to step S413.

In step S413, the server 101 adds the current job of interest as the settlement target job. After completion of addition, the processing proceeds to step S414.

In step S414, the server 101 determines whether the current job of interest is the last one of the jobs extracted from the job history. If the current job of interest is not the last one (NO in step S414), the processing proceeds to step S415. If the current job of interest is the last one (YES in step S414), the processing proceeds to step S416.

In step S415, the server 101 focuses on the next job, and then the processing returns to step S410 to continue the processing.

On the other hand, in step S416, it is determined whether the display target job and the settlement target job are present as a result of processing. If the display target job and the settlement target job are present (YES in step S416), the processing proceeds to step S419. If the display target job and the settlement target job are not present (NO in step S416), the processing proceeds to step S417.

In step S417, the server 101 generates a response indicating that there is no display target job and transmits the generated response to the mobile information terminal 121.

### <Mobile Information Terminal 121>

In step S418, the mobile information terminal 121 receives the response indicating that there is no display target job from the server 101, displays a screen indicating that there is no job to be processed, and terminates the processing.

### <Server 101>

In step S419, the server 101 generates data for displaying a list of processing (display and settlement) target jobs using the job information list presentation/selection reception unit 133.

In step S420, the server 101 determines whether there is any job that is already added to the list as the settlement target job. If there is a job added to the list as the settlement target job (YES in step S420), the processing proceeds to step S421. If there is no job added to the list as the settlement target job (NO in step S420), the processing proceeds to step S422.

In step S421, the server 101 adds information indicating that the settlement target job is already selected as the settlement target job. Then, the processing proceeds to step S422.

In step S422, the server 101 transmits the generated job list data to the mobile information terminal 121 through the job information list presentation/selection reception unit 133.

### <Mobile Information Terminal 121>

In step S423, the mobile information terminal 121 receives the job list data and displays the job list data on a screen.

### (Job Selection Screen)

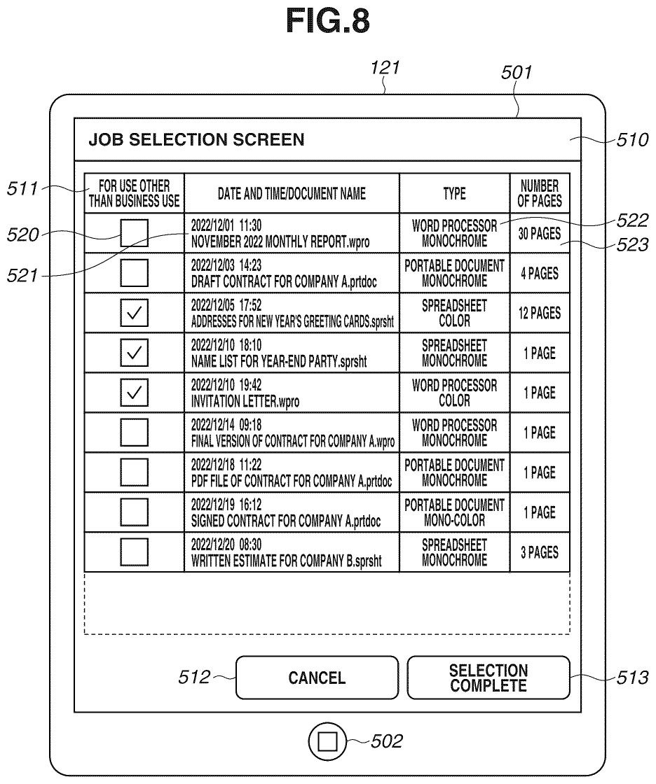

FIG. 8 illustrates a screen on which a job list is displayed. While FIG. 8 illustrates a display example in which the job list is displayed on the screen of the application, the job list may also be displayed on a screen of a website.

A screen 501 is displayed on a display portion of the mobile information terminal 121.

A button 502 is a physical button on the mobile information terminal 121. Since there are various types of mobile information terminals 121, the display illustrated in FIG. 8 is merely an example. For example, the button 502 may be omitted and a button may be displayed on the screen 501, or the screen 501 may be displayed by some operation.

A screen title or the like is displayed on a header 510 of the screen 501.

A job list display 511 is generated by the server 101 according to the first exemplary embodiment and is displayed on the mobile information terminal 121. When a [cancel] button 512 is pressed, the previous operation is cancelled. A [selection complete] button 513 is used to complete and terminate the job selection operation.

A checkbox 520 is used for the user to select a job in the job list display 511. When the user selects the checkbox 520 in an unselected state, a check mark is displayed on the checkbox 520. When the user selects the checkbox 520 in the checked state, the state of the checkbox 520 transitions from the checked state to the unselected state. In step S421, the checkbox 520 corresponding to the job to which settlement target information is added may be displayed in a state where the checkbox 520 is selected and is in the checked state.

On a display field 521 indicating a date and time when a job is processed and a document name of the job, time when the job is input to the second image forming apparatus 122 and the print job document name indicated as No. 3 in Table 1 are displayed.

On a display field 522 indicating a document type, information including a document format and color information, such as full-color, monochrome, or mono-color, is displayed.

On a display field 523 indicating the number of pages of a document, the total number of documents of the document is displayed.

Referring again to the flowchart of FIG. 7B, in step S424, the mobile information terminal 121 receives the operation performed on the screen 501 by the user. The user checks the checkbox 520 corresponding to a job for use other than business use on the screen 501 to thereby select the settlement target job. Then, the user presses the [selection complete] button 513 to thereby perform a selection complete operation. When the user operates the [selection complete] button 513, the processing of the mobile information terminal 121 proceeds to step S425.

In step S425, the mobile information terminal 121 determines whether there is any job selected as the settlement target job when the user has finally pressed the [selection complete] button 513. If the CPU 241 of the mobile information terminal 121 determines that there is a job selected as the settlement target job (YES in step S425), the processing proceeds to step S426.

On the other hand, if the CPU 241 of the mobile information terminal 121 determines that there is no job selected as the settlement target job (NO in step S425), the processing proceeds to step S431. In step S431, information indicating that there is no selected job is transmitted to the server 101, and then the processing ends.

In step S426, the mobile information terminal 121 transmits the settlement target job selection result to the server 101.

In step S427, the server 101 receives the settlement target job selection result.

In step S428, the server 101 receives the selection result through the job information list presentation/selection reception unit 133 and performs processing on the selection result.

In step S429, the server 101 causes the billing information generation unit 132 to calculate a billing amount on the job selected as the settlement target based on a billing rule based on a job attribute value if there is such a billing rule based on the job attribute value. If there is no such billing rule, the billing amount is calculated based on a general billing rule.

Next, in step S430, the server 101 transmits billing amount information to the mobile information terminal 121 through the billing information/settlement presentation reception unit 134.

### <Mobile Information Terminal 121>

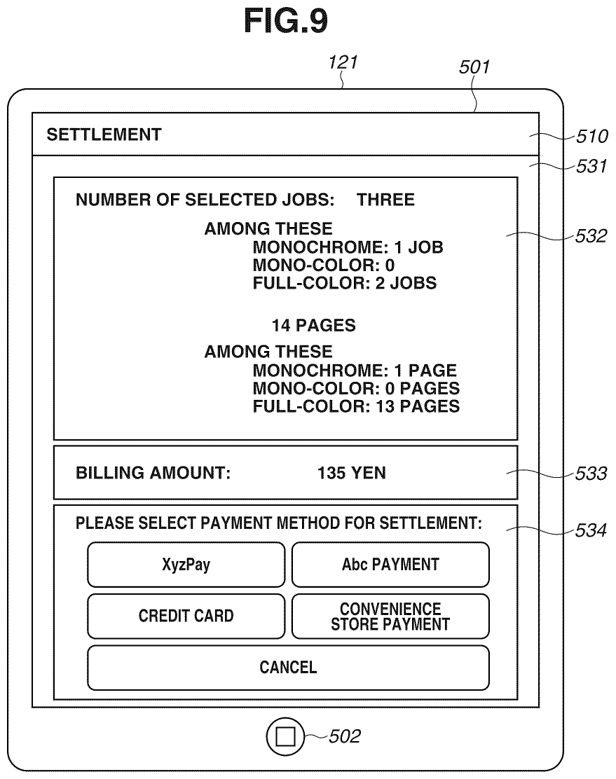

In step S432, the mobile information terminal 121 receives the billing amount information, displays the billing amount information on the screen 501, and presents options for a settlement method so that the user can perform settlement processing. Specifically, the mobile information terminal 121 displays a settlement method presentation screen 531 as illustrated in FIG. 9 to be described below.

### (Settlement Method Presentation Screen)

FIG. 9 illustrates an example of a screen for displaying a billing amount and presenting a settlement method.

The header 510 and the settlement screen 531 are displayed on the screen 501. The settlement screen 531 includes an area 532 on which aggregated information about selected jobs is displayed, an area 533 on which the billing amount is displayed, and an area 534 on which options for the settlement method are displayed.

The area 532 is an area on which aggregated information about selected jobs is displayed. In this case, the area 532 indicates that there are three jobs in which printing is executed for use other than business use based on the screen illustrated in FIG. 8, including “1” job for monochrome printing, “0” job for mono-color printing, and “2” jobs for full-color printing. The area 532 also indicates that the total number of monochrome pages is “1”, the total number of mono-color pages is “0”, and the total number of full-color pages is “13”.

The area 533 is an area on which the billing amount is presented. In this case, the area 533 indicates an example where the cost of full-color printing per page is 10 YEN and the cost of monochrome printing per page is 5 YEN. According to this billing rule, the total billing amount for the jobs to be settled is 135 YEN.

The area 534 is an area on which a settlement method is selected. In this case, the area 534 indicates an example where buttons corresponding to smartphone settlement methods [XyzPay] and [Abc payment], a button corresponding to a settlement method using [credit card], and a button corresponding to [convenience store payment] for payment at a cash register of a convenience store can be selected. As the settlement method to be used, it may be desirable to select a settlement method that can be applied for convenience for the user to preferably use the settlement method.

Referring again to FIG. 7B and the description of the processing flow is continued.

In step S433, an operation of pressing a settlement method button or the [cancel] button by the user is received. Although there may be cases where the screen may transition to a screen for settlement during the operation, or an operation may be received in a state where settlement processing is not actually completed on the spot, detailed descriptions of such cases are omitted.

After completion of payment processing or cancellation, the processing proceeds to step S434.

In step S434, it is determined whether the “cancel” operation is performed. If the “cancel” operation is performed (YES in step S434), the processing proceeds to step S435. If the billing information/settlement presentation reception unit 134 has received “settlement complete” (NO in step S434), the processing proceeds to step S439.

In step S435, the mobile information terminal 121 transmits information indicating that the cancel operation is performed to the server 101.

### <Server>

In step S436, the server 101 receives the information indicating that the “cancel” operation is performed and performs cancellation processing.

In step S437, a response indicating that the “cancel” operation is received is transmitted to the mobile information terminal 121.

### <Mobile Information Terminal>

In step S438, the mobile information terminal 121 displays the information indicating that the “cancel” operation is received on the display, and then this processing ends.

In step S439 to be executed after it is determined that the “cancel” operation is not performed in step S434, the mobile information terminal 121 transmits settlement information to the server 101.

### <Server>

In step S440, the server 101 executes settlement processing, and then the processing proceeds to step S441.

In step S441, the server 101 generates a response indicating “settlement complete” and transmits the generated response to the mobile information terminal 121.

### <Mobile Information Terminal 121>

In step S442, the mobile information terminal 121 displays information indicating “settlement complete” on the display, and then this processing ends.

In the first exemplary embodiment of the present disclosure described above, printing for business use can be performed using, for example, the second image forming apparatus 122 and the second information processing device 123 that are placed in the remote working environment 120, such as a user's place, during remote working using the second image forming apparatus 122 and the second information processing device 123. In addition, the second image forming apparatus 122 can also be used for printing for any use other than business use. In this case, printing for any use other than business use can be performed by preliminarily setting the billing destination identification number for printing for any use other than business use and assigning the billing destination identification number to the job. However, printing for any use other than business use can also be performed more easily in a normal way by omitting the operation of assigning the billing destination identification number. During a unit period of a contract, at a certain timing, for example, before or after a deadline, jobs to which the billing destination identification numbers are not assigned can be listed, and jobs for any use other than business use can be selected from the list and settlement processing on the selected jobs can be completed using any settlement method.

This eliminates the need for making a special preparation in advance during printing or during settlement processing on a job that is not based on the contract. Consequently, advantageous effects of readily performing jobs for any use other than business use and facilitating the user to more effectively use an image forming apparatus installed in an environment such as a user's place can be obtained. For example, if printing is executed on an image forming apparatus installed in a user's place, it is difficult to comprehensively prepare for information about the user that is assumed to use printing for any use other than business use. As a result, it may be difficult to determine whether each print job is a print job for business use or a print job for any use other than business use. In a case where each user that uses print services makes a contract, it is difficult to make an arrangement on a payment procedure for settlement of costs for all users that use print jobs for any use other than business use in advance.

If there are some print jobs that cannot be determined to be a print job for business use or a print job for any use other than business use, and if a smooth payment procedure for print jobs for any use other than business use is not determined in advance, the payment procedure based on the contract cannot be completed rapidly. According to the present disclosure, an advantageous effect of solving such an issue can also be obtained.

In the first exemplary embodiment described above, the system for sorting print jobs for each billing contract during settlement processing is described. In a second exemplary embodiment of the present disclosure, a system in which a function for issuing an alert when the amount or printing approaches an upper limit set in a contract is added to the configuration of the system according to the first exemplary embodiment will be described.

Next, the second exemplary embodiment of the present disclosure will be described with reference to the drawings. An overall configuration of a system according to the second exemplary embodiment of the present disclosure is similar to that schematically illustrated in FIG. 1.

A software configuration of the server 101 will be described with reference to FIG. 2B.

A contractual job amount upper limit checking unit 141 determines whether the job amount has approached an upper limit based on the contract.

An alert issuance unit 142 transmits a notification indicating that the job amount has approached the upper limit based on the contract to a person in charge of the contract that uses the service, or to the user.

In the second exemplary embodiment of the present disclosure, hardware configurations of the first and second image forming apparatuses 112 and 122, the first and second information processing devices 111 and 123, and the mobile information terminal 121 are similar to the hardware configuration illustrated in FIG. 5.

In the second exemplary embodiment of the present disclosure, processing to be performed when the second information processing device 123 executes printing on the second image forming apparatus 122 by a user operation is similar to that illustrated in FIG. 6.

### Alert Issuance Processing Based on Number of Print Jobs

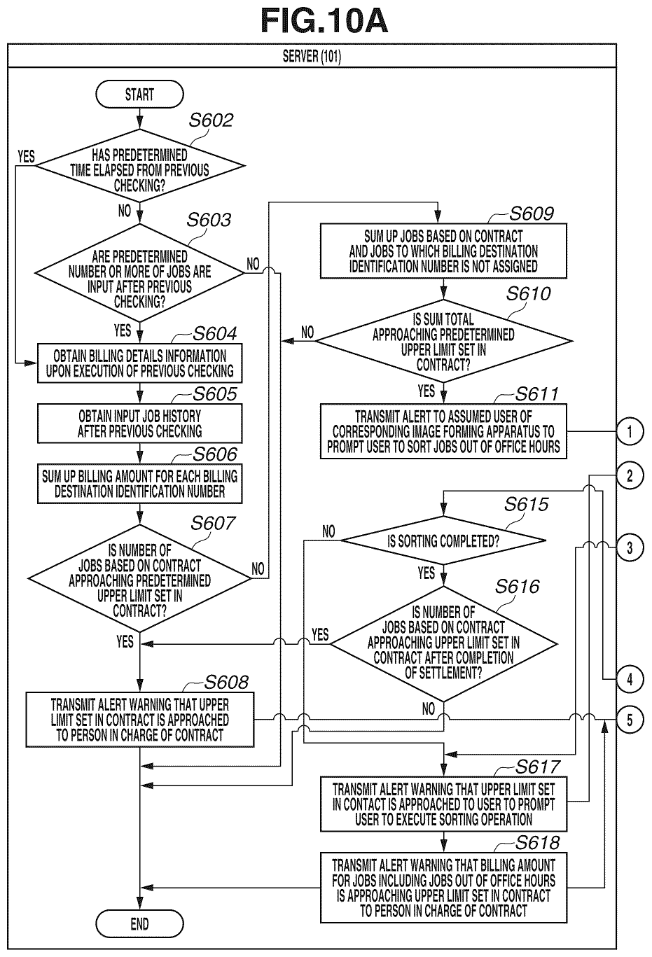

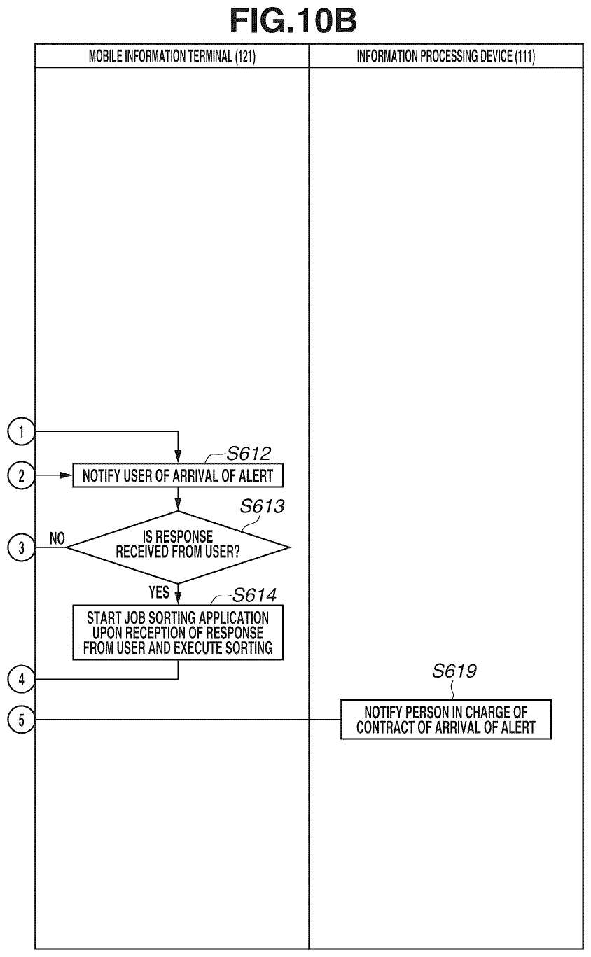

Periodic checking processing to be executed every predetermined period by the system according to the present exemplary embodiment even in a state where there is no access from the user, regardless of an event, such as a deadline, during a unit period of the contact will be described with reference to a flowchart of FIGS. 10A and 10B. This processing is implemented such that the CPU of the server 101 loads programs into the RAM and executes the programs.

### <Server 101>

In step S602, the server 101 checks whether a predetermined period has elapsed from time when checking is previously performed by this processing on any processing target image forming apparatus. If the server 101 determines that the predetermined period has elapsed (YES in step S602), the processing proceeds to step S604. If the predetermined period has not elapsed (NO in step S602), the processing proceeds to step S603.

In step S603, the server 101 determines whether a predetermined number or more of job are input after the previous checking processing using the print job information storage unit 131. If the server 101 determines that the predetermined number or more of job are input (YES in step S603), the processing proceeds to step S604. If the predetermined number or more of job are not input (NO in step S603), the processing ends.

If the predetermined period has elapsed after the previous checking processing, or if the predetermined number or more of job are input although the predetermined period has not elapsed, the processing proceeds to step S604.

In step S604, the server 101 obtains billing details information during execution of the previous checking processing through the billing information generation unit 132.

In step S605, the server 101 obtains a history of jobs input after the previous checking processing from the print job information storage unit 131.

In step S606, the server 101 sums up the billing amount for each billing destination identification number (No. 4 in Table 1) using the billing information generation unit 132. Specifically, the billing amount for the jobs input after the previous checking processing is added and calculated for billing details information during the previous checking processing. Further, the server 101 sums up the jobs for which the billing destination is uncertain.

In step S607, the server 101 determines whether the number of jobs based on the contract at the time has exceeded a predetermined ratio (threshold) with respect to the upper limit set in the contract, or whether the number of jobs has approached the upper limit. If the server 101 determines that the number of jobs has approached the upper limit (YES in step S607), the processing proceeds to step S608. If the number of jobs has not approached the upper limit (NO in step S607), the processing proceeds to step S609.

In step S609, the server 101 sums up the number of jobs that are based on the contract and the number of jobs to which the billing destination identification number is not assigned, or the number of jobs for which the billing destination is uncertain.

In step S610, the server 101 determines whether the sum total has exceeded the predetermined ratio (threshold) with respect to the upper limit set in the contract, or whether the sum total has approached the upper limit. If the server 101 determines that the sum total has not approached the upper limit (NO in step S610), the processing ends. If the sum total has approached the upper limit (YES in step S610), the processing proceeds to step S611.

In step S611, the server 101 transmits an alert for prompting the user to sort jobs for any use other than business use and perform settlement processing to the user that is assumed to use the second image forming apparatus 122 at ordinary times and resides in the remote working environment 120.

### <Mobile Information Terminal 121>

In step S612, the mobile information terminal 121 notifies the user of arrival of the alert. In general, the alert is received by the application on the mobile information terminal 121 and is displayed on the screen of the application. However, the alert cannot be displayed in some cases depending on the operating state of the mobile information terminal 121. In any case, the alert is issued so that the user can notice the alert during use of the mobile information terminal 121.

In step S613, the mobile information terminal 121 determines a response is received from the user. If the server 101 determines that the response is received from the user and the application on the mobile information terminal 121 is opened (YES in step S613), the processing proceeds to step S614. If the application is not opened (NO in step S613), the processing proceeds to step S617.

In step S614, the mobile information terminal 121 starts an application for job sorting, and prompts the user to execute sorting. Actual processing for the user to perform job sorting and settlement processing is executed by processing based on the flowcharts illustrated in FIGS. 7A and 7B. After the execution of the processing is completed, the application on the mobile information terminal 121 notifies the server 101 of the processing result, and then the processing proceeds to step S615.

### <Server 101>

In step S615, the server 101 determines whether sorting is completed by the user. If the server 101 determines that sorting is completed (YES in step S615), the processing proceeds to step S616. If sorting is not completed (NO in step S615), the processing proceeds to step S617.

In step S616, the server 101 determines whether the billing amount for jobs based on the contract has approached the upper limit set in the contract by the billing information generation unit 132 in a state where the settlement processing is completed using the contractual job amount upper limit checking unit 141. If the server 101 determines that the billing amount has approached the upper limit set in the contract (YES in step S616), the processing proceeds to step S608. If the billing amount has not approached the upper limit (NO in step S616), the processing ends.

In step S608, the server 101 issues an alert indicating that the number of jobs based on the contract has approached the upper limit set in the contract to the person in charge of the contract using the alert issuance unit 142. The person in charge of the contract is not limited to an individual person in charge, but instead may be, for example, a department in charge or a plurality of persons in charge to which the alert may be issued at once. Same applies to the term “person in charge of the contract” used in the following exemplary embodiments. The present exemplary embodiment is described assuming that the information processing device used by the person in charge of the contract is placed in an office as the first information processing device 111.

The server 101 transmits the alert to the person in charge of the contract, and then the processing ends.

### <Information Processing Device 111>

In step S619, when the first information processing device 111 that is used by the person in charge of the contract has received the alert, the first information processing device 111 transmits a notification to the account of the person in charge of the contract in an operating system incorporated in the first information processing device 111. In many cases, this notification is issued in a form in which, for example, the notification is displayed on a screen in a state where the person in charge of the contract is using the first information processing device 111.

### <Server 101>

In step S617, the server 101 issues an alert indicating that the billing amount for jobs has approached the upper limit set in the contract in a state where the jobs include jobs that may be jobs for any use other than the use covered in the contract to the user using the alert issuance unit 142. In this state, the server 101 transmits an alert for prompting the user to execute the operation of selecting jobs for any use other than business use and billing processing as soon as possible.

The mobile information terminal 121 receives this alert in step S612 and transmits a notification to the user. The subsequent processing is similar to that described above.

In step S617, the server 101 transmits the alert, and then the processing proceeds to step S618.

In step S618, the server 101 further transmits an alert indicating that the billing amount for jobs has approached the upper limit set in the contract in a state where the jobs include jobs that may be jobs for any use other than business use to a person in charge of the contract using the alert issuance unit 142.

### <Information Processing Device 111>

In step S619, the first information processing device 111 receives the alert and transmits a notification to the person in charge of the contract. The alert is similar to that transmitted in step S608. After completion of transmission of the alert on the server 101, the processing ends.

According to the second exemplary embodiment of the present disclosure described above, for example, in a case where a predetermined number of jobs that can be input within a month is set based on the monthly billing amount, when the number of jobs has approached the upper limit before a deadline, an alert can be issued to the person in charge of the contract.

Further, if the jobs that have approached the upper limit include jobs which may be jobs for any use other than business use and to which the billing destination identification number (No. 4 in Table 1) is not assigned, an alert can be issued to the user of the second image forming apparatus 122.

Further, selection of jobs for any use other than business use may be confirmed and settlement processing may be performed on the selected jobs on the spot, thereby making it possible to determine whether the number of jobs based on the contract has actually approached the upper limit. In other words, it is possible to reliably determine whether the number of jobs based on the contract has approached the upper limit within the period of the contract and it is also possible to issue an alert.

Consequently, an advantageous effect of avoiding a situation where the user is unaware that the number of jobs covered in the contract has exceeded the upper limit and an excess amount of money is billed can be obtained.

In a third exemplary embodiment of the present disclosure, preview checking of a thumbnail of a document during sorting of print jobs in the first exemplary embodiment facilitates the user to sort print jobs.

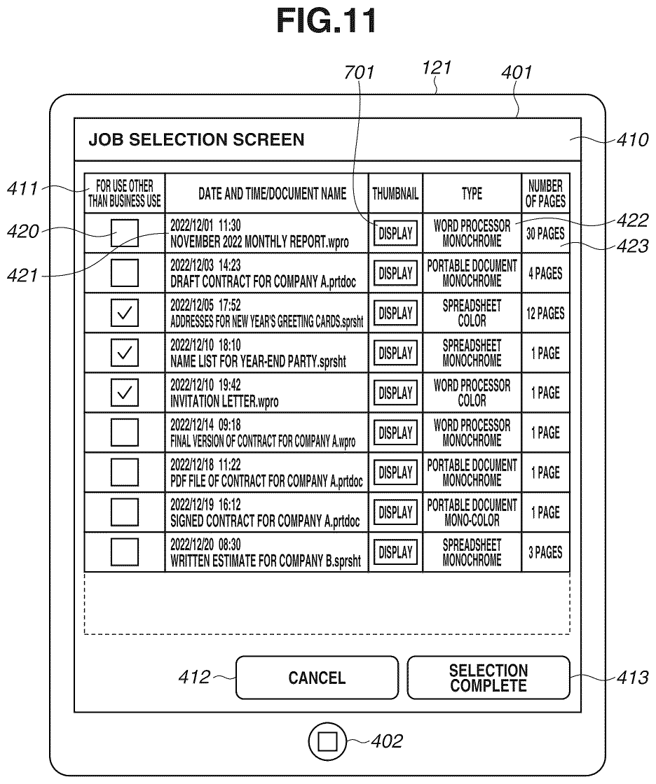

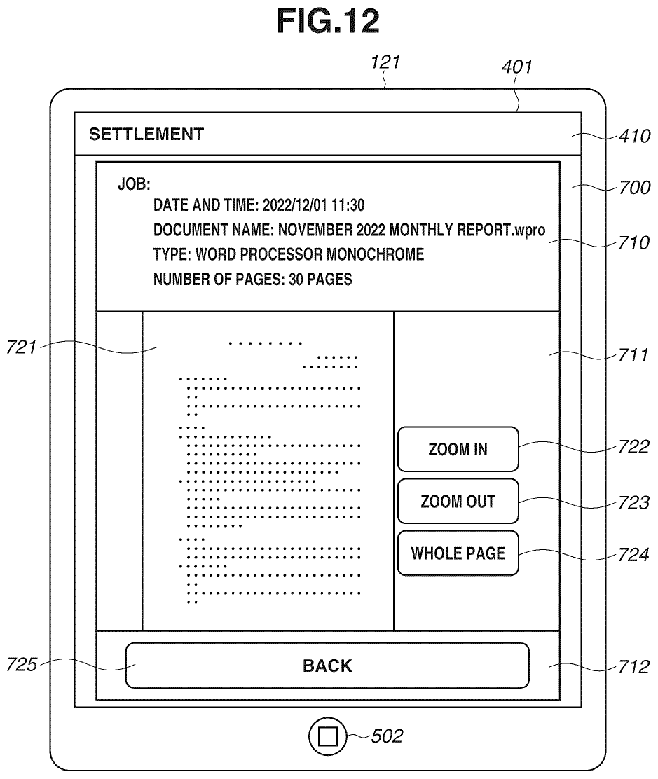

Next, the third exemplary embodiment of the present disclosure will be described with reference to FIGS. 11 and 12. An overall configuration of a system according to the third exemplary embodiment is similar to that illustrated in FIG. 1.

In the third exemplary embodiment of the present disclosure, processing to be performed when the second information processing device 123 executes printing on the second image forming apparatus 122 by a user operation is similar to that illustrated in FIG. 6. In this case, data to be transmitted to the server 101 from the second image forming apparatus 122 includes not only the data illustrated in Table 1 and Table 2, but also data illustrated in Table 3.

TABLE 3

| | Information | |
|---|---|---|
| No. | Item Name | Information Content |
| 10 | Print job | A zoomed-out image of a print sheet screen |
| | thumbnail | image in a predetermined number of pages at |
| | | beginning of a print job |

The second image forming apparatus 122 forms a print job, and then saves a number of thumbnail images of the print sheet corresponding to the predetermined number of pages and adds the thumbnail images to data to be transmitted to the server 101.

A flow of processing from sorting of print jobs by the user to settlement processing on jobs for any use other than business use according to the third exemplary embodiment of the present disclosure is similar to that illustrated in FIGS. 7A and 7B.

In the third exemplary embodiment of the present disclosure, the hardware configurations of the first and second image forming apparatuses 112 and 122, the first and second information processing devices 111 and 123, and the mobile information terminal 121 are respectively similar to the hardware configurations schematically illustrated in FIGS. 3, 4, and 5.

FIG. 11 illustrates a screen example when the mobile information terminal 121 according to the third exemplary embodiment of the present disclosure displays job list data on the screen in step S423. Descriptions of components that are common to those illustrated in FIG. 8 are omitted. A thumbnail display button 700 that is used to display a thumbnail is provided for each job. When the user presses the thumbnail display button 700, the screen is switched to a thumbnail display screen illustrated in FIG. 12.

An area 710 is an area for displaying a document attribute value. In this case, for example, a date and time, a document name, a type, and the number of pages are displayed on the area 710.

An area 711 is an area for displaying a thumbnail image.

A thumbnail image 721 is a zoomed-out image of a print sheet image in a print job. When the user presses a [zoom-in] button 722, a zoomed-in thumbnail image can be displayed. When the user presses a [zoom-out] button 723, the zoomed-in thumbnail image can be zoomed out and displayed. A [whole page] button 724 is a button for displaying the whole page again. When the user presses the [whole page] button 724, the display can be returned to the display of the original whole page regardless of the enlargement ratio of the current display of the thumbnail image.

An area 712 is an area for displaying a [back] button 725. The [back] button 725 is a button for returning to a job list display screen 401 illustrated in FIG. 11.

In the third exemplary embodiment, periodic checking processing may be executed every predetermined period even in a state where there is no access from the user, regardless of an event, such as a deadline, during a unit period of the contract. A flow of processing to be performed when such periodic checking processing is executed is similar to that illustrated in FIGS. 10A and 10B.

As described above, the use of the third exemplary embodiment of the present disclosure enables the user to refer to a thumbnail image for each job, as needed, thereby making it possible to easily determine whether the job is a job for any use other than business use.

Consequently, an advantageous effect of more easily achieving job sorting processing and prompting the user to use the second image forming apparatus 122 for any use other than business use is obtained.

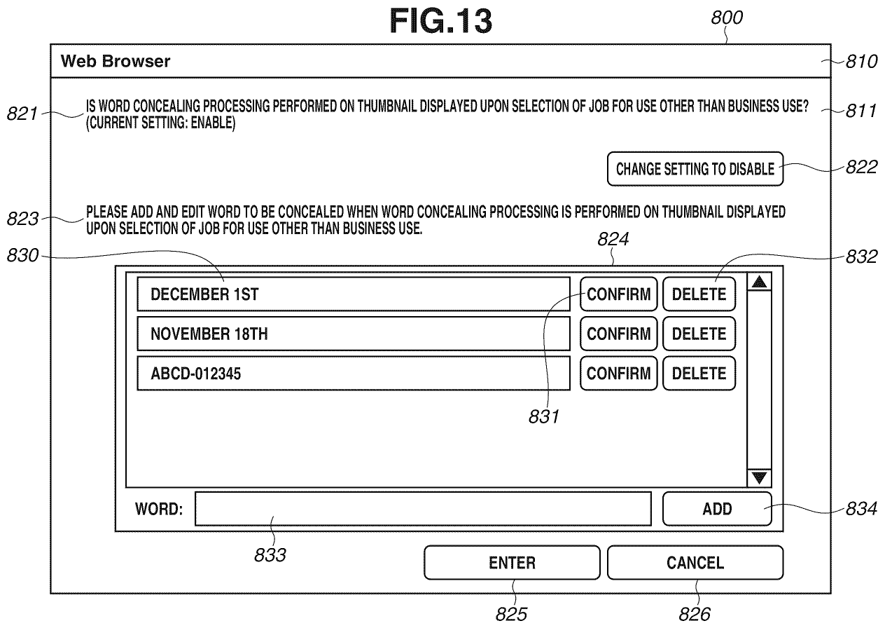

Next, a fourth exemplary embodiment of the present disclosure will be described with reference to FIG. 13. An overall configuration of a system according to the fourth exemplary embodiment of the present disclosure is similar to that illustrated in FIG. 1.

FIG. 2C illustrates a software configuration of the server 101.

A word concealment setting unit 151 is a unit for holding settings for a word concealment function.

In the fourth exemplary embodiment of the present disclosure, processing to be performed when the second information processing device 123 executes printing on the second image forming apparatus 122 by a user operation is similar to that illustrated in FIG. 6.

In the fourth exemplary embodiment of the present disclosure, hardware configurations of the first and second image forming apparatuses 112 and 122, the first and second information processing devices 111 and 123, and the mobile information terminal 121 are respectively similar to the hardware configurations schematically illustrated in FIGS. 3, 4, and 5.

In the system according to the present exemplary embodiment, a flow of processing from sorting of print jobs by the user to settlement processing on jobs for any use other than business use is similar to that illustrated in the flowchart of FIGS. 10A and 10B.

A flow of periodic checking processing to be executed every predetermined period even in a state where there is no access from the user, regardless of an event, such as a deadline, during a unit period of the contract, in the system according to the present exemplary embodiment is similar to that schematically illustrated in the flowchart of FIG. 6.

Contents to be displayed on the screen of the application on the mobile information terminal 121 during processing from sorting of jobs illustrated in FIG. 5 to settlement processing on jobs for any use other than business use according to the fourth exemplary embodiment of the present disclosure are similar to the contents illustrated in FIG. 11.

### (Contract Content Setting Screen)

FIG. 13 illustrates an example of a screen to be presented as a website screen or the like on, for example, the web browser of the first information processing device 111 when the server 101 sets the concealment function for the service user in the fourth exemplary embodiment of the present disclosure.

A screen 800 is a window of the web browser.

A header 810 is a header portion of the window.

A content display area 811 is a content display portion of the web browser.

A message 821 is a message for the server 101 to send an inquiry about whether to apply and execute processing of concealing a word on a thumbnail to the service user. This message is displayed together with information indicating whether the word concealment function is currently enabled. A [change setting to disable] button 822 is a button for switching “enable” and “disable” of the word concealment function. If the current setting value indicates “enabled”, the [change setting to disable] button 822 functions to change the setting to “disable”. If the current setting value indicates “disabled”, the [change setting to disable] button 822 functions to change the setting to “enable”.

A message 823 is a message indicating that specific words to be concealed are designated as a character string when the word concealment function is enabled.

An area 824 is a control area for holding, editing, deleting, or adding a word to be concealed in the word concealment function. An [enter] button 825 is used to send an instruction to perform an operation for transmitting and saving changes added by a user operation. When the user presses the [enter] button 825, the first information processing device 111 transmits information within the page to the server 101 and saves the information in the server 101. A [cancel] button 826 is a button for instructing an operation for discarding and cancelling the changes made by a user operation. When the user presses the [cancel] button 826, all the changes made within the page by the user are discarded.

An entry field 830 is an input area for a word to be concealed in the word concealment function. A [confirm] button 831 is a button for confirming the word input in the entry field 830 as the target word to be concealed. When the user performs an operation to change the content of the entry field 830 and presses the [confirm] button 831, the content currently held in the entry field 830 is confirmed as the target word to be concealed. A [delete] button 832 is a button for deleting the confirmed content held in the entry field 830. Even if the user has overwritten the content of the entry field 830, the content of the entry field 830 before the content is overwritten is valid before the [confirm] button 831 is pressed and can be deleted. When the content is deleted, the deleted word is not selected as the target word to be concealed again.

A word entry field 833 is an area for adding a new target word to be concealed. An [add] button 834 is a button for adding the word input in the word entry field 833 as the target word to be concealed.

The content confirmed as the target word to be concealed when the user performs an operation such as confirmation or deletion by adding or changing the content in the area 824 is sent to the server 101 when the user has finally pressed the [enter] button 825, and the content is received by the server 101 and is validated. If the [cancel] button 826 is pressed, the content is not sent to the server 101 and is not finally validated. In this case, the previously enabled setting is maintained.

Table 4 illustrates operation examples of the word concealment function. For example, assume that six words of “December 1st”, “November 18th”, “ABCD-012345”, “launch”, “announce”, and “new product” are set as target words to be concealed. In this case, if concealing processing is enabled, the server 101 executes character recognition processing on a thumbnail image displayed on the screen as illustrated in FIG. 12. Matching between the set words and words in character strings obtained as a result of the processing is detected. If the set words match words in the character strings, the concealing processing is performed by replacing the words with, for example, a black square “▪”. Table 4 illustrates a result of the concealing processing.

TABLE 4

| Example of Original Text | Concealing Processing Result |
|---|---|
| The launch of a new product is | ▪ ▪ of ▪ ▪ ▪ is scheduled on |
| scheduled on December 1st | ▪ ▪ |
| The presentation of the new product | ▪ ▪ of ▪ ▪ ▪ is scheduled on |
| is scheduled on November 18th | ▪ ▪ |
| The new product “ABCD-012345” is | ▪ ▪ ▪ |
| scheduled to be available | “▪ ▪ ▪ ▪ ▪ ▪ ▪ ▪ ▪ ▪ ▪” |
| | is scheduled to ▪ ▪ |

As described above, the use of the fourth exemplary embodiment of the present disclosure makes it possible to prevent information to be concealed by the service user from being read from the corresponding thumbnail image when a job is selected and settlement processing on the job is performed using the second image forming apparatus 122 in the remote working environment 120.

Thus, the server 101 can present a thumbnail image in a state where important information is concealed even when the person that uses the second image forming apparatus 122 for use other than business use has no relation with the service user that resides in the remote working environment 120. Therefore, the person can execute job sorting and settlement processing without contacting information important for the service user. As a result, anyone can use the second image forming apparatus 122 placed in the remote working environment 120, and anyone can easily sort jobs and perform settlement processing on the jobs used by the person.

Consequently, the user-friendliness of the second image forming apparatus 122 can be greatly enhanced.

### Other Exemplary Embodiments

The present disclosure can also be implemented by the following processing. That is, a program for implementing one or more functions according to the exemplary embodiments described above is supplied to a system or an apparatus via a network or a storage medium, and one or processors in a computer of the system or the apparatus read out the program and execute the program. The present disclosure can also be implemented by a circuit (e.g., an application-specific integrated circuit (ASIC)) for implementing one or more functions according to the exemplary embodiments described above.

In a billing system according to an aspect of the present disclosure, a user of an image forming apparatus can use the image forming apparatus regardless of the intended use and settlement processing can be selectively performed on jobs for any use other than business use.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-209108, filed Dec. 12, 2023, which is hereby incorporated by reference herein in its entirety.

What is claimed is:

1. A server communicably connected to an information processing device and an image forming apparatus via a network, the server comprising:
at least one memory storing at least one program; and
at least one processor, the at least one processor configured to execute the at least one program to perform processing comprising:
storing information input from a first information processing device indicating a print job executed by the image forming apparatus;
generating billing information based on a first rule for a print job based on a contract and a second rule for a print job not based on the contract and for use other than business use;
causing a display unit of a second information processing device to display a screen displaying a list of a print job not based on the contract and for use other than business use and a print job not based on the contract and not confirmed as a print job for use other than business use in the stored print job information;
receiving a selection of a print job not based on the contract and for use other than business use as a settlement target job by a user from the list of print jobs;
causing the display unit to display a settlement screen for presenting billing information and a settlement method based on the second rule for the selected print job; and
executing settlement processing based on an operation performed by the user.

2. The server according to claim 1, wherein the second information processing device is a mobile information terminal.

3. The server according to claim 1, wherein the second information processing device corresponds to the first information processing device.

4. The server according to claim 1, wherein the print job information includes information for identifying an image forming apparatus that has executed a print job.

5. The server according to claim 1, a print job that is not based on the contract and is confirmed as a print job for use other than business use is displayed on the screen as a selected settlement target job.

6. The server according to claim 1, wherein on the settlement screen, the number of printed pages and a billing amount are presented as billing information.

7. The server according to claim 1, wherein on the settlement screen, options for the settlement method are presented as buttons.

8. The server according to claim 1, wherein in a case where a billing amount for print jobs set in the contract approaches an upper limit an alert is issued prompting the user to select a print job not based on the contract and for use other than business use to the second information processing device.

9. The server according to claim 1, wherein in a case where the user selects a print job not based on the contract and for use other than business use and completes settlement processing, if a billing amount for print jobs covered in the contract approaches an upper limit, an alert is issued to a person in charge of the contract of a third information processing device.

10. The server according to claim 1, wherein the screen for displaying the list of print jobs includes a button for switching the list of print jobs to a screen for displaying a thumbnail of a document for each print job.

11. The server according to claim 1, wherein in a case where a word to be concealed is set and a thumbnail of a document for the print job is displayed, the set word is displayed as a hidden character.

12. A method of a server communicably connected to an information processing device and an image forming apparatus via a network, the method comprising:
storing information input from a first information processing device indicating a print job executed by the image forming apparatus;
generating billing information based on a first rule for a print job based on a contract and a second rule for a print job not based on the contract and for use other than business use;
causing a display unit of a second information processing device to display a screen displaying a list of a print job not based on the contract and for use other than business use and a print job not confirmed as a print job for use other than business use in the stored print job information;
receiving a selection of a print job not based on the contract and for use other than business use as a settlement target job by a user from the list of print jobs;
causing the display unit to display a settlement screen for presenting billing information and a settlement method based on the second rule for the selected print job; and
executing settlement processing based on an operation performed by the user.

13. A storage medium storing a computer program for causing a computer to execute a method of a server communicably connected to an information processing device and an image forming apparatus via a network, the method comprising:
storing information input from a first information processing device indicating a print job executed by the image forming apparatus;
generating billing information based on a first rule for a print job based on a contract and a second rule for a print job not based on the contract and for use other than business use;
causing a display unit of a second information processing device to display a screen displaying a list of a print job not based on the contract and for use other than business use and a print job not confirmed as a print job for use other than business use in the stored print job information;
receiving a selection of a print job not based on the contract and for use other than business use as a settlement target job by a user from the list of print jobs;
causing the display unit to display a settlement screen for presenting billing information and a settlement method based on the second rule for the selected print job; and
executing settlement processing based on an operation performed by the user.

14. A system comprising:
a server;
an information processing device;
an image forming apparatus;
a first information processing device; and
a second information processing device,
wherein the server, the information processing device, the image forming apparatus, the first information processing device, and the second information processing device are communicably connected via a network,
wherein the image forming apparatus is configured to execute print processing on a received print job and transmit data on a print job to the server,
wherein the first information processing device is configured to input the print job to the image forming apparatus,
wherein the second information processing device is configured to display a list of print jobs and receive a selection of a print job by a user and a settlement operation, and
wherein the server is configured to:
store information input from the first information processing device and indicating a print job executed by the image forming apparatus;
generate billing information based on a first rule for a print job based on a contract and a second rule for a print job not based on the contract and for use other than business use;
cause a display unit of the second information processing device to display a screen displaying a list of a print job not based on the contract and for use other than business use and a print job not based on the contract and not confirmed as a print job for use other than business use in the stored print job information;
receive a selection of a print job not based on the contract and for use other than business use as a settlement target job by a user from the list of the print jobs;
causing the display unit to display a settlement screen for presenting billing information and a settlement method based on the second rule for the selected print job; and
execute settlement processing based on an operation performed by the user.
